(19) United States
(12) Patent Application Publication
(10) Pub. No.: US 2020/0234228 A1
(43) Pub. Date: Jul. 23, 2020

(54) METHOD

(71) Applicant: ROLLS-ROYCE plc, London (GB)

(72) Inventors: Sarah E TOOZE, Birmingham (GB); Thomas D MELIA, Loughborough (GB); Thomas J GREEN, Derby (GB)

(73) Assignee: ROLLS-ROYCE plc, London (GB)

(21) Appl. No.: 16/741,817

(22) Filed: Jan. 14, 2020

(30) Foreign Application Priority Data
Jan. 21, 2019 (GB) 1900794.7

(51) Int. Cl. G06Q 10/08; F01D 25/12; G06Q 10/00

(52) U.S. Cl. CPC G06Q 10/087; F05D 2220/32; G06Q 10/20; F01D 25/12

(57) ABSTRACT

A set of gas turbine engine components comprises N gas turbine engine components. Each gas turbine engine component has a respective flow value. A method for selecting the N gas turbine engine components includes ordering the gas turbine engine components in dependence upon their respective flow value. For each ordered group of components a maximum range is determined for the respective flow values. If this maximum range is less than a pre-determined range limit then the ordered group becomes a set. If this criteria is not met then another component is added to the group, the group is reordered by flow value and the range check is repeated with allowable groups forming selected sets and further components being added as required.

This disclosure claims the benefit of UK Patent Application No. GB 1900794.7, filed on 21 Jan. 2019, which is hereby incorporated herein in its entirety.

### FIELD OF THE DISCLOSURE

The present disclosure relates to a method of selecting components based on a component characteristic and particularly, but not exclusively, to a method of selecting turbomachinery blades based on an internal blade flow characteristic.

### BACKGROUND TO THE DISCLOSURE

Rotating components in a gas turbine engine are subject to high mechanical stresses and elevated temperature environments. Long term exposure to these conditions cause solid material to deform permanently over time (this phenomenon is called material creep). Excessive material creep can lead to component failure. Creep life is a measure of how much time a component can withstand these conditions before a creep induced failure occurs.

In a gas turbine engine the high pressure (HP) turbine blade creep life can be shown to be a function of the blade cooling flow-rate with a higher cooling flow-rate correlating directly with a higher creep life.

In a set of turbine blades having a higher average cooling flow-rate, the blade feed pressure ratio will be lower than normal. The term Blade Feed Pressure Ratio (BFPR) is defined as the driving pressure feeding the set of blades, relative to a main annulus pressure at a particular location within the turbine. In other words, an increased BFPR means an increase in driving pressure for the blade since the main annulus pressure can be assumed to be fixed. This can be a problem for any turbine blades in the set that have a low cooling flow-rate. Blades having a low cooling flow-rate in an above average flow set will ‘see’ a lower blade feed pressure ratio than is optimal and so will suffer from even lower cooling flow than a nominal blade. These blades will degrade much faster than the rest of the set and since only one blade is required to fail to drive an engine off wing, the rest of the set does not see their full life potential and will be replaced at shop visit. This is costly, time-consuming and inconvenient for a user.

Being able to group turbine blades into sets of similarly flowing blades will better match all of the blades to the set blade feed pressure ratio and ensure that no one or two blades get punished in a set. Across the fleet this leads to a significant average life improvement in HP turbine blades.

U.S. Pat. No. 7,021,892 B2 discloses a method of assembling gas turbine components with internal cooling passages into sets “classified according to flow capability”. The components are grouped into sets or ‘classes’ of similar flow-rate to achieve a component life improvement by better matching the component's cooling flow feed pressure ratios. The method requires prescribed ‘classes’ for the component cooling flow-rate levels. Clearly if the manufacturing process is not evenly spread some of these classes will take longer to fill and make an engine set than others which is costly and time consuming for a user.

### Statements of Disclosure

According to a first aspect of the present disclosure there is provided a method of selecting sets of gas turbine engine components, each set comprising N gas turbine engine components, and each gas turbine engine component having a respective flow value, the flow value for each of the gas turbine engine components being within the range of C±t, where C is a nominal target value and t is an allowable variation from the nominal target value, the method comprising the steps of:
(i) selecting a pre-determined allowable range value for the flow values of the gas turbine engine components, the pre-determined allowable range value being less than 2*t;
(ii) providing a stock of N gas turbine engine components;
(iii) ordering the N gas turbine engine components in dependence upon their respective flow value;
(iv) for the N gas turbine engine components, determining a maximum range value between the highest flow value and the lowest flow value;
(v) if the maximum range value is equal to or less than the pre-determined allowable range value, then assigning the N gas turbine engine components as a set, and repeating steps (ii) to (iv);
(vi) if the maximum range value is greater than the pre-determined allowable range value, then adding an additional gas turbine engine component to the stock;
(vii) ordering the stock of gas turbine engine components in dependence upon their respective flow values;
(viii) for each group of sequential N gas turbine engine components within the ordered stock, determining a maximum range value between the highest flow value and the lowest flow value;
(ix) if the maximum range value for any group of sequential N gas turbine engine components is equal to or less than the pre-determined allowable range value, then assigning the group of sequential N gas turbine engine components having the lowest maximum range value as a set;
(x) if the maximum range value for any group of sequential N gas turbine engine components is greater than the pre-determined allowable range value, then adding an additional gas turbine engine component to the stock; and
(xi) repeating steps (vii) to (x) in dependence upon the quantity of sets of gas turbine engine components that may be required.

The method of the disclosure enables the selection of sets of engine components in which all of the components have a flow value within a smaller range than the normal allowable variation from the nominal target value. The method of the disclosure allows this smaller range to move from set to set within the allowable variation from the nominal target value.

The method of the disclosure also allows for each set to have a narrower distribution of flow values between components in a single set than if the components were selected randomly from all those components having a flow value within the normal allowable variation from the nominal target value.

The selection of the pre-determined allowable range value is a trade-off between the additional costs associated with an increased stock of components, and the predicted service life improvement associated with the narrower distribution of flow values between components in a single set.

In one arrangement the pre-determined allowable range value is selected at the start of the procedure and remains in place until all of the required sets have been selected. In another arrangement, the pre-determined allowable range value may be selected before each of the sets is selected.

The dynamic limit selection technique of the disclosure provides advantages over the prior art technique of grouping components into subcategories within the normal allowable variation from the nominal target value. Specifically, the method of the disclosure requires fewer components in order to complete a set thus resulting in lower inventory costs and shorter time to complete a set. This makes the method of the disclosure cheaper, quicker and more convenient to implement for a user.

According to a second aspect of the present disclosure there is provided a method of selecting M sets of gas turbine engine components, each set comprising N gas turbine engine components, and each gas turbine engine component having a respective flow value, the method comprising the steps of:
(i) providing a stock of (M*N) gas turbine engine components;
(ii) ordering the (M*N) gas turbine engine components in dependence upon their respective flow value; and
(iii) dividing the ordered (M*N) gas turbine engine components into M sequentially ordered sets of N gas turbine engine components.

In an alternative selection method, a quantity of sets of components can be selected in a single set of operations. This alternative method also provides for the selection of sets of engine components in which all of the components have a flow value within a smaller range than the normal allowable variation from the nominal target value. This is because the entire normal allowable variation from the target value is divided across the M sets of components. This in turn makes the alternative method more convenient for a user.

In this way the methods of each of the first and second aspects share the common feature of enabling the selection of sets of components, each having a flow value, in which each set of components has a smaller variation in flow value between individual components than if the set was to be composed of components selected randomly from the full allowable variation from the target value.

Optionally, the pre-determined allowable range value is determined in dependence on a distribution of the flow values within the allowable variation (t) from the nominal target value (C).

Optionally, the pre-determined allowable range value is determined in dependence on a time-history of the flow values as the components are manufactured.

Knowing the variability of the flow values with time enables an assessment of how long it would take to build up the sets.

Optionally, the pre-determined allowable range value is 0.4*(2*t).

As outlined above, with the pre-determined allowable range value being less than 2*t, the generated sets of components will provide a service life benefit over sets of randomly selected components.

This requirement must be balanced against the increased quantity of components that will be required in order to enable the selection of sets of components meeting the range value criterion.

The pre-determined allowable range value is 0.4*(2*t) provides a balance between these two requirements.

Optionally, step (i) comprises the step of
(i)′ providing the stock of gas turbine engine components in a time ordered sequence;

This means taking the components in time sequence from the manufacturing process for input to the method of the disclosure. This makes the method straightforward and convenient for a user.

Optionally, each gas turbine engine component has an internal cooling flow, and the respective flow value is a flow-rate value for the internal cooling flow.

In one arrangement, the gas turbine engine component has one or more internal cooling passages and a cooling air flow is circulated through the or each passage to cool the component. In such an arrangement the flow value is a flow-rate value for the cooling air flow.

For example, the gas turbine engine component may be a turbine blade or a compressor blade. In other arrangements the component may be a guide vane, for example a nozzle guide vane or an intermediate guide vane.

According to a third aspect of the present disclosure there is provided a computer program that, when read by a computer, enables performance of the method according to either of the first and second aspects.

According to a fourth aspect of the present disclosure there is provided a non-transitory computer readable storage medium comprising computer readable instructions that, when read by a computer, enables performance of the method according to either of the first and second aspects.

According to a fifth aspect of the present disclosure there is provided a signal comprising computer readable instructions that, when read by a computer, causes performance of the method according to either of the first and second aspects.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

Other aspects of the disclosure provide devices, methods and systems which include and/or implement some or all of the actions described herein. The illustrative aspects of the disclosure are designed to solve one or more of the problems herein described and/or one or more other problems not discussed.

### BRIEF DESCRIPTION OF THE DRAWINGS

There now follows a description of an embodiment of the disclosure, by way of non-limiting example, with reference being made to the accompanying drawings in which:

FIG. 1 shows a sectional side view of a gas turbine engine;

FIG. 2 shows a flow chart detailing a method according to a first embodiment of the disclosure; and

FIG. 3 shows a flow chart detailing a method according to a second embodiment of the disclosure.

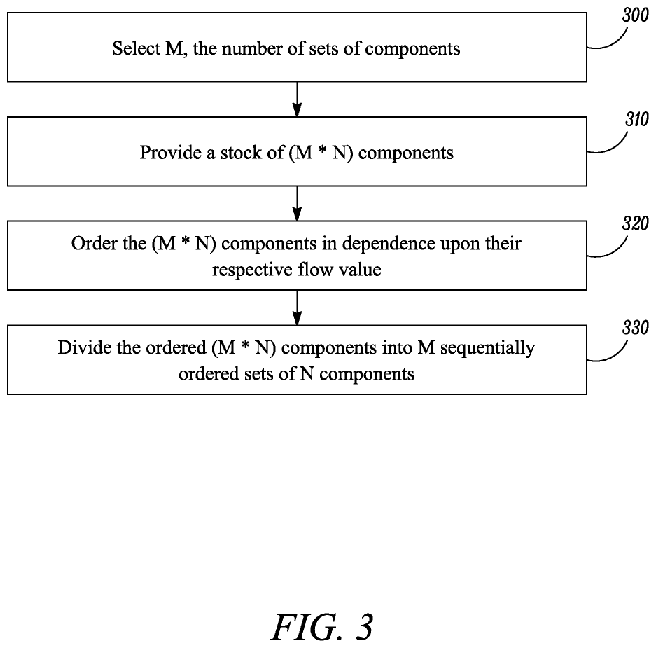

It is noted that the drawings may not be to scale. The drawings are intended to depict only typical aspects of the disclosure, and therefore should not be considered as limiting the scope of the disclosure. In the drawings, like numbering represents like elements between the drawings.

### DETAILED DESCRIPTION

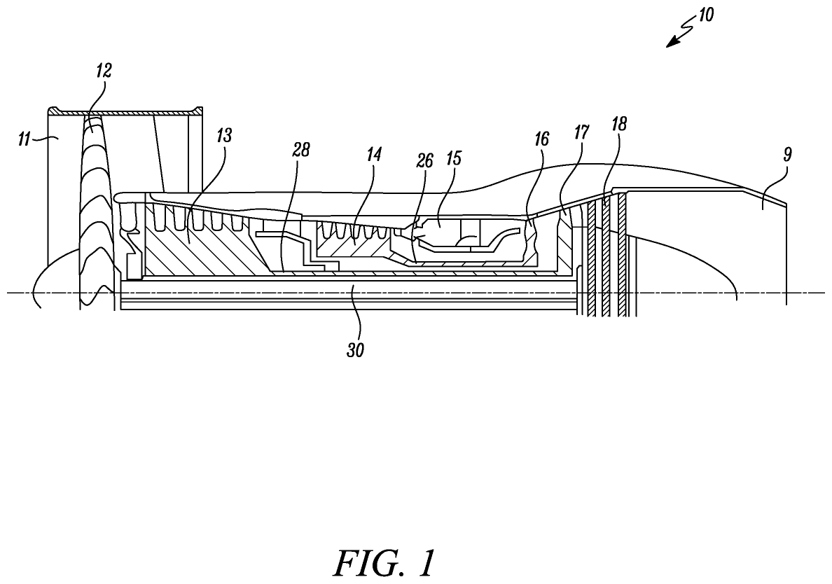

A turbofan gas turbine engine 10, as shown in FIG. 1, comprises in flow series an intake 11, a fan 12, an intermediate pressure compressor 13, a high pressure compressor 14, a combustion chamber 15, a high pressure turbine 16, an intermediate pressure turbine 17, a low pressure turbine 18 and an exhaust 19. The high pressure turbine 16 is arranged to drive the high pressure compressor 14 via a first shaft 26. The intermediate pressure turbine 17 is arranged to drive the intermediate pressure compressor 13 via a second shaft 28 and the low pressure turbine 18 is arranged to drive the fan 12 via a third shaft 30. In operation air flows into the intake 11 and is compressed by the fan 12. A first portion of the air flows through, and is compressed by, the intermediate pressure compressor 13 and the high pressure compressor 14 and is supplied to the combustion chamber 15. Fuel is injected into the combustion chamber 15 and is burnt in the air to produce hot exhaust gases which flow through, and drive, the high pressure turbine 16, the intermediate pressure turbine 17 and the low pressure turbine 18. The hot exhaust gases leaving the low pressure turbine 18 flow through the exhaust 19 to provide propulsive thrust. A second portion of the air bypasses the main engine to provide propulsive thrust.

Each of the intermediate pressure turbine 17 and the high pressure turbine 16 comprises a circumferential array of turbine blades. These turbine blades are provided with internal cooling flow passages, each of which has an associated cooling flow rate when in normal operation.

It is understood from the operation of a gas turbine engine that a set of blades having internal flow passages that are high flowing will have a lower Blade Feed Pressure Ratio (BFPR) than will a set of blades that are low flowing.

Consequently, a low flowing blade within a high flowing set of blades will experience a lower BFPR and therefore a lower flow than a nominal flow rated blade having a nominal BFPR.

Sets of blades that have a large standard deviation and/or high skewness in their flow values will have blades in the above scenario which will lead to a higher Tₘₑₜₐₗ for the lowest flowing blades.

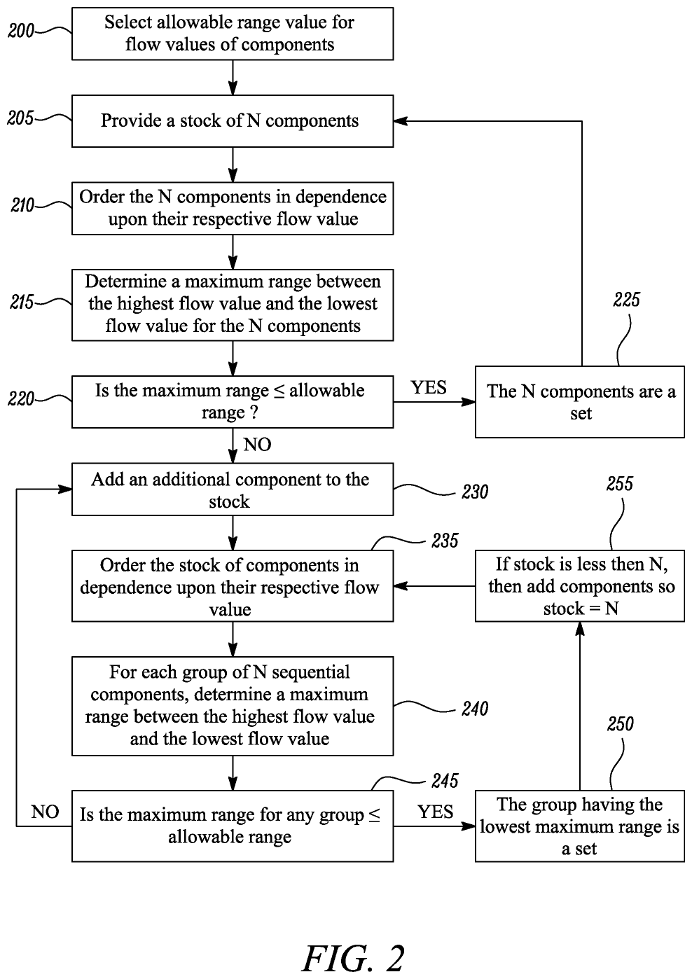

FIG. 2 shows a flow chart detailing a method of selecting sets of gas turbine engine components. In the following disclosure these gas turbine engine components are high pressure turbine blades. However, the method of the disclosure is equally applicable to the selection of other turbine blades (i.e. from the intermediate pressure compressor) or compressor blades. Likewise the method may be applied to the selection of other turbomachinery components having an associated flow characteristic.

At step 200 an allowable range value is selected for the flow values of the components in the stock. This range is a trade-off between the additional costs associated with an increased stock of components, and the predicted service life improvement associated with the narrower distribution of flow values between components in a single set. The trade-off is assessed using knowledge of current manufacturing capability, including (but not necessarily limited to):

(i) knowledge of the distribution of flow values within the allowable variation (t) from the nominal target value (C); and

(ii) knowledge of the time-history of flow values as the components are manufactured within the facility. Knowing the variability of the flow values with time enables an assessment of how long it would take to build up the sets.

A stock of N components is provided as a starting point in step 205, where N (an integer) is the quantity of components that comprise an individual set. In this embodiment the stock of N components is provided in a time ordered sequence. In other words, the stock is accumulated in the order in which the components are produced. In this way the method of the disclosure can be applied on a real-time basis to the component production process.

This stock of N components is then ordered at step 210, in dependence on the respective flow values for each component. For example the components can be ordered by ascending flow value. In the present example the flow value is a flow-rate value. However in an alternative arrangement this flow value might equally be a flow pressure or a flow temperature.

At step 215 a maximum range value is determined for the set of N components; this maximum range value being the difference in flow values between the highest flow value and the lowest flow value for the N components.

This maximum range value is then compared in step 220 to the pre-determined allowable range value (selected at step 200).

If the maximum range value is less than or equal to the allowable range value then the stock of N components becomes a set of components at step 225, and the activity returns to step 205 with a fresh set of N components.

However, if the maximum range value is greater than the allowable range value then an additional component is added to the stock at step 230. At this point the stock comprises (N+1) components.

The stock of components is then ordered at step 235, again in dependence upon their respective flow value. At this point there is more than one group of sequentially ordered (by flow value) components. For example following the first instance where an additional component is added, there will be two groups of sequentially ordered components, namely 1→N and 2→(N+1).

For each group of N sequentially ordered components (at step 240) a maximum range is determined between the highest flow value and the lowest flow value. In the example from the last paragraph there will then be two maximum range values; one for each of the 1→N and 2→(N+1) groups.

At step 245 each of these maximum range values is compared to the pre-determined allowable range value (from step 200).

If the maximum range value is less than or equal to the allowable range value then the group of N components having the lowest maximum range value becomes a set of components at step 250. At this point, if the stock is less than N components then additional components are added to the stock (at step 255) to bring the quantity back to N, and the activity returns to step 235 in readiness for the stock to be reordered.

However, if the maximum range value is greater than the allowable range value then an additional component is added to the stock at step 230 and steps 235 to 245 are repeated.

The method illustrated in the flow chart of FIG. 2 can be worked for as long as required to obtain the required quantity of sets of engine components.

FIG. 2 shows a flow chart detailing a method of selecting sets of gas turbine engine components according to a second embodiment of the disclosure.

The method of FIG. 2 starts at step 300 with a selection of the quantity M (an integer) of sets of components that are to be selected.

At step 310 a stock of (M*N) components is provided, where N (an integer) is the quantity of components that comprise an individual set. In this embodiment the stock of (M*N) components is provided in a time ordered sequence. In other words, the stock is accumulated in the order in which the components are produced. In this way the method of the disclosure can be applied on a real-time basis to the component production process.

The collection of (M*N) components is then ordered in dependence upon the respective flow values of the components. As outlined above this step of ordering may be by ascending flow value. Similarly, the flow value while a flow-rate value in the present example may alternatively be some other flow characteristic such as pressure or temperature).

The ordered collection of (M*N) components is then divided (at step 330) into M sequentially ordered sets of N components each.

For example if four sets of components are to be selected then M=4,and if each set comprises 80 components, then the ordered collection of (M*N) components will comprise 320 components. The selected sets will then be components 1 to 80, 81 to 160, 161 to 240, and 241 to 320.

In one or more examples, the operations described may be implemented in hardware, software, firmware, or any combination thereof. If implemented in software, the operations may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a processor, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Moreover, in determining extent of protection, due account shall be taken of any element which is equivalent to an element specified in the claims. Various changes to the described embodiments may be made without departing from the spirit and scope of the invention.

In addition, where a range of values is provided, it is understood that every intervening value, between the upper and lower limit of that range and any other stated or intervening value in that stated range, is encompassed within the invention.

Except where mutually exclusive, any of the features may be employed separately or in combination with any other features and the disclosure extends to and includes all combinations and sub-combinations of one or more features described herein.

Although specific advantages have been enumerated above, various embodiments may include some, none, or all of the enumerated advantages.

What is claimed is:

1. A method of selecting sets of gas turbine engine components, each set comprising N gas turbine engine components, and each gas turbine engine component having a respective flow value, the flow value for each of the gas turbine engine components being within the range of C±t, where C is a nominal target value and t is an allowable variation from the nominal target value, the method comprising the steps of:
(i) selecting a pre-determined allowable range value for the flow values of the gas turbine engine components, the pre-determined allowable range value being less than 2*t;
(ii) providing a stock of N gas turbine engine components;
(iii) ordering the N gas turbine engine components in dependence upon their respective flow value;
(iv) for the N gas turbine engine components, determining a maximum range value between the highest flow value and the lowest flow value;
(v) if the maximum range value is equal to or less than the pre-determined allowable range value, then assigning the N gas turbine engine components as a set, and repeating steps (ii) to (iv);
(vi) if the maximum range value is greater than the pre-determined allowable range value, then adding an additional gas turbine engine component to the stock;
(vii) ordering the stock of gas turbine engine components in dependence upon their respective flow values;
(viii) for each group of sequential N gas turbine engine components within the ordered stock, determining a maximum range value between the highest flow value and the lowest flow value;
(ix) if the maximum range value for any group of sequential N gas turbine engine components is equal to or less than the pre-determined allowable range value, then assigning the group of sequential N gas turbine engine components having the lowest maximum range value as a set;
(x) if the maximum range value for any group of sequential N gas turbine engine components is greater than the pre-determined allowable range value, then adding an additional gas turbine engine component to the stock; and
(xi) repeating steps (vii) to (x) in dependence upon the quantity of sets of gas turbine engine components that may be required.

2. A method of selecting M sets of gas turbine engine components, each set comprising N gas turbine engine components, and each gas turbine engine component having a respective flow value, the method comprising the steps of:
(i) providing a stock of (M*N) gas turbine engine components;
(ii) ordering the (M*N) gas turbine engine components in dependence upon their respective flow value; and
(iii) dividing the ordered (M*N) gas turbine engine components into M sequentially ordered sets of N gas turbine engine components.

3. The method as claimed in claim 1, wherein the pre-determined allowable range value is determined in dependence on a distribution of the flow values within the allowable variation (t) from the nominal target value (C).

4. Method as claimed in claim 1, wherein the pre-determined allowable range value is determined in dependence on a time-history of the flow values as the components are manufactured.

5. The method as claimed in claim 1, wherein the pre-determined allowable range value is 0.4*(2*t).

6. The method as claimed in claim 1, wherein step (i) comprises the step of
(i)′ providing the stock of gas turbine engine components in a time ordered sequence;

7. The method as claimed in claim 1, wherein each gas turbine engine component has an internal cooling flow, and the respective flow value is a flow-rate value for the internal cooling flow.

8. A computer program that, when read by a computer, enables performance of the method as claimed in claim 1.

9. A non-transitory computer readable storage medium comprising computer readable instructions that, when read by a computer, enables performance of the method as claimed in claim 1.

10. A signal comprising computer readable instructions that, when read by a computer, causes performance of the method as claimed in claim 1.
